(19) United States
(12) Patent Application Publication
(10) Pub. No.: US 2007/0126949 A1
(43) Pub. Date: Jun. 7, 2007

(54) DISPLAY DEVICE

(75) Inventors: Sung-Min KIM, Yongin-si, Gyeonggi-do (KR); Jeong-Seok OH, Seoul (KR); Jeung-Soo KIM, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/565,845

(22) Filed: Dec. 1, 2006

(30) Foreign Application Priority Data
Dec. 7, 2005 (KR) 10-2005-0118472

(51) Int. Cl. G02F 1/1335

(52) U.S. Cl. 349/65

(57) ABSTRACT

A display device includes a display panel, a first light unit, a second light unit, a first buffer member and a second buffer member. The display panel is disposed between the first and second light units, and displays an image. The first light unit is disposed on a first side of the display panel and supplies light to the display panel. The second light unit is disposed on a second side opposite to the first side of the display panel and supplies light to the display panel. The first buffer member is disposed between the display panel and the first light unit. The second buffer member is disposed between the display panel and the second light unit. Thus, a light guide plate included in each of the light units is substituted for a conventional window to reduce a thickness of the display device.

This application claims priority to Korean Patent Application No. 2005-118472, filed on Dec. 7, 2005, and all the benefits accruing therefrom under 35 USC § 119, the contents of which in its entirety are herein incorporated by reference.

### BACKGROUND OF THE INVENTION

1. Field of the Invention

The present invention relates to a display device. More particularly, the present invention relates to a display device capable of reducing a thickness thereof.

2. Description of the Related Art

In general, a liquid crystal display (“LCD”) apparatus displays images by using a light transmittance varied in accordance with an intensity of an electric field. An LCD apparatus having various characteristics, for example, such as a small size, low power consumption, a high resolution, etc., is widely applied to electronic instruments, for example, such as a notebook computer, a monitor, a mobile communication system and so on.

An LCD apparatus, usually, displays an image in one direction. However, as there has been a trend of employing multiple display units displaying images in different directions, display devices have been developed to display images in multiple directions, primarily in two directions.

The display device for displaying images in two directions includes an upper case and a lower case for fixing the display module, and has a window. The window is spaced apart from the display module by a predetermined distance. The window corresponds to respective opening portions of the upper case and the lower case.

Therefore, a thickness of the conventional display module is relatively thick and a whole thickness of the display device increases due to using the window.

### BRIEF SUMMARY OF THE INVENTION

The present invention has been made to solve the above problems of the prior art, and therefore, a first aspect of the present invention is to provide a display device with a reduced thickness.

In an exemplary embodiment of the present invention, a display device includes a display panel, a first light unit, a second light unit, a first buffer member and a second buffer member. The display panel is disposed between the first and second light units, and displays an image. The first light unit is disposed on a first side of the display panel and supplies light to the display panel. The second light unit is disposed on a second side opposite to the first side of the display panel and supplies light to the display panel. The first buffer member is disposed between the display panel and the first light unit. The second buffer member is disposed between the display panel and the second light unit.

In another exemplary embodiment of the present invention, a display device includes a display module, a first case and a second case. The display module includes a display panel for displaying an image, a first light unit disposed on a first side of the display panel, the first light unit for supplying light to the display panel, a second light unit disposed on a second side opposed to the first side of the display panel, the second light unit for supplying light to the display panel, a first buffer member disposed between the display panel and the first light unit and a second buffer member disposed between the display panel and the second light unit. The first case fixes the first light unit. The second case fixes the second light unit, and the second case is combined with the first case.

In still another exemplary embodiment of the present invention, a display device includes a display panel, a light unit, an opposite plate and a buffer member. The display panel is configured to display an image. The light unit is disposed on a first side of the display panel, and is configured to supply light to the display panel. The opposite plate is disposed on a second side of the display panel. The buffer member is disposed between the display panel and the light unit.

According to the above, the present invention provides a display device for reducing a thickness thereof considerably.

### BRIEF DESCRIPTION OF THE DRAWINGS

The above and other aspects, features and advantages of the present invention will become readily apparent by reference to the following detailed description when considered in conjunction with the accompanying drawings wherein:

FIG. 1 is a perspective view showing a mobile communication apparatus having a display device according to an exemplary embodiment of the present invention;

FIG. 2 is an exploded perspective view showing a portion of the display device shown in FIG. 1;

FIG. 3 is a cross-sectional view showing a portion of the display device shown in FIG. 1;

FIG. 4 is an exploded perspective view showing the display module in FIG. 2;

FIG. 5 is an enlarged cross-sectional view showing a portion A in FIG. 3;

FIG. 6 is a plan view showing a schematic diagram of the display panel in FIG. 4; and

FIG. 7 is a cross-sectional view showing a display device in accordance with another embodiment of the present invention.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

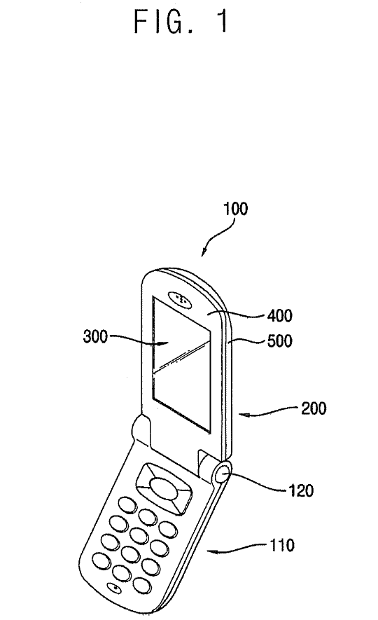

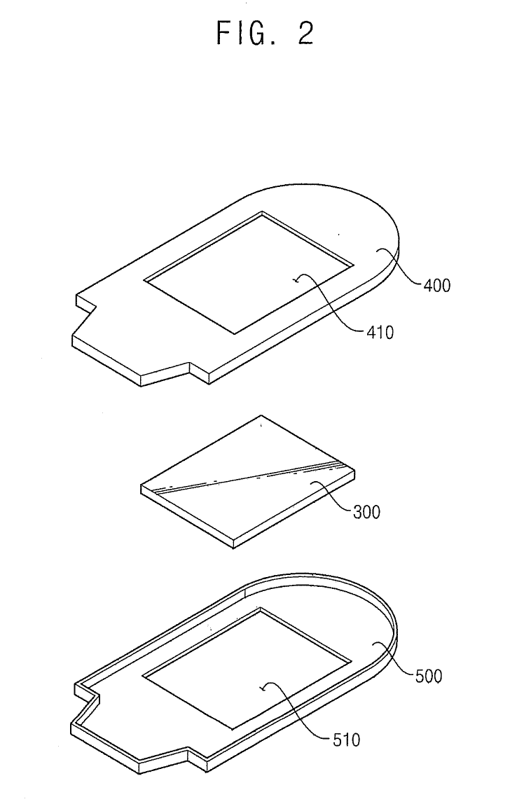

FIG. 1 is a perspective view showing a mobile communication apparatus having a display apparatus according to an exemplary embodiment of the present invention. FIG. 2 is an exploded perspective view showing a portion of the display apparatus shown in FIG. 1.

Referring to FIGS. 1 and 2, a mobile communication apparatus 100 includes an information processing device 110 for processing communication information and a display device 200 for displaying images by using data processed by the information processing device 110.

The information process device 110′ includes a keypad for a user to input information, a microphone for receiving sound information of a user, circuit devices, and so on.

The display device 200 is combined with the information process device 110 by a hinge portion 120, and a hinge portion 120 allows the display device to be opened and shut down the information process device 110.

The display device 200 includes a display module 300 for displaying an image in two directions, a first case 400 and a second case 500 for receiving and fixing the display module 300.

The first and second cases 400 and 500 are combined with each other to define a receiving space, and the display module 300 is disposed in the receiving space.

The first case 400 includes a first opening portion 410 for exposing an upper side of the display module 300, and a second opening portion 500 for exposing a lower side of the display module 300.

When the first and second cases 400 and 500 are combined with each other, an outer surface of the first case 400 is substantially coplanar with the upper side of the display module 300 and an outer surface of the second case 500 is substantially coplanar with the lower side of the display module 300.

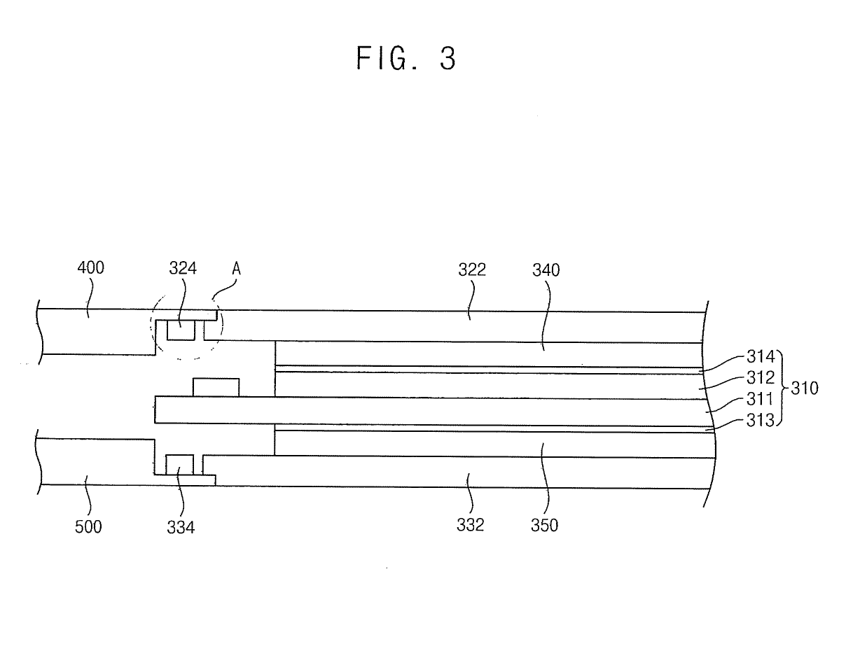

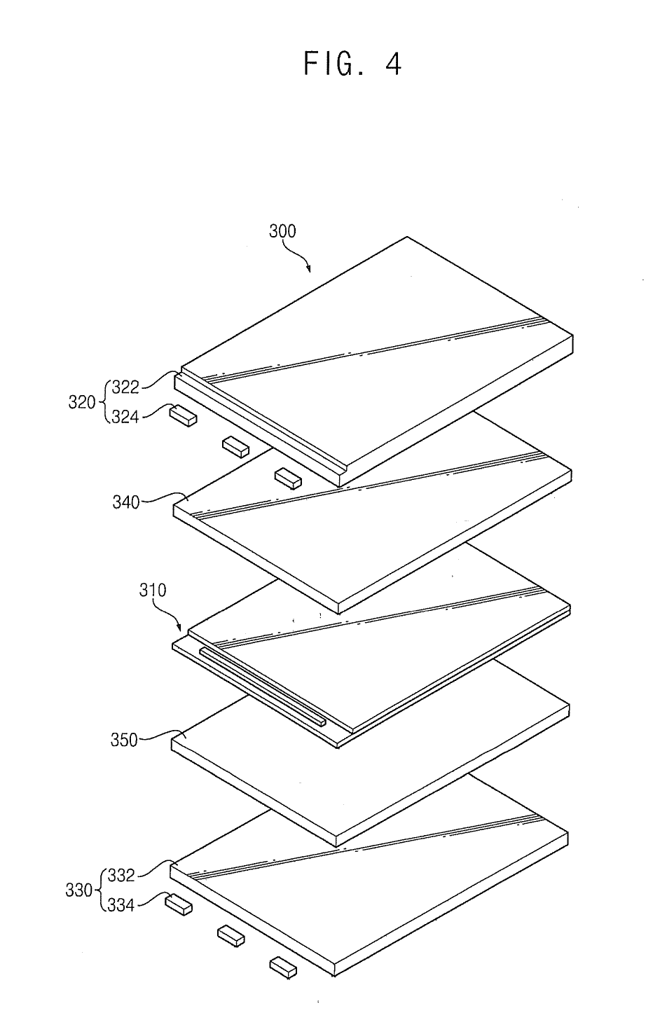

FIG. 3 is a cross-sectional view showing a portion of the display device shown in FIG. 1. FIG. 4 is an exploded perspective view showing the display module in FIG. 2.

Referring to FIGS. 3 and 4, the display module 300 includes a display panel 310, a first light unit 320, a second light unit 330, a first buffer member 340 and a second buffer member 350.

The display panel 310 displays an image in two directions by using light supplied from the first light unit 320 and the second light unit 330.

The first light unit 320 is disposed on a first side of the display panel 310 and supplies the display panel 310 with a first light.

The second light unit 320 is disposed on a second side opposite to the first side of the display panel 310 and supplies the display panel 310 with a second light.

The first buffer member 340 is disposed between the display panel 310 and the first light unit 320. The first buffer member 340 absorbs an external impact applied to the display panel 310 via the first light unit 320 and protects the display panel 310.

The second buffer member 350 is disposed between the display panel 310 and the second light unit 330. The second buffer member 350 absorbs an external impact applied to the display panel 310 via the second light unit 330 and protects the display panel 310.

The first buffer member 340 and the second buffer member 350 desirably include resins having a predetermined elasticity.

Also, the first and second buffer members 340 and 350 desirably include transparent materials for transmitting light. For example, the first buffer member 340 and the second buffer member 350 include silicon or poly methyl methacrylate (PMMA).

Furthermore, the first and second buffer members 340 and 350 desirably have an adhesive property in order to increase coherence between the first light unit 320, the second light unit 330 and the display panel 310.

The display panel 310 displays a main-image toward the second light unit 330 by using the first light supplied from the first light unit 320. Also, the display panel 310 displays a sub-image toward the first light unit 320 by using the second light supplied from the second light unit 330.

The main-image and the sub-image displayed by the display panel 310 may be the same or different. The main-image and the sub-image are controlled by supplying the display panel 310 with a same image signal or a different image signal on the basis of operation of the first light unit 320 and the second light unit 330.

The display panel 310 is a transmissive type panel, and the display panel 310 displays the main-image by using the first light supplied from the first light unit 320 and displays the sub-image by using the second light supplied from the second light unit 330.

When the first and second light units 320 and 330 operate together, power consumption increases and personal private information may be leaked. Therefore, the second light unit 330 does not operate when the first light unit 320 is operated, and the first light unit 320 does not operate when the second light unit 330 is operated.

The display panel 310 includes a first substrate 311, a second substrate 312 opposite to the first substrate 311 and a liquid crystal layer interposed between the first and second substrates 311 and 312.

The display panel 310 may include a first polarizing plate 313 attached on an outer surface of the first substrate 311 and a second polarizing plate 314 attached on an outer surface of the second substrate 314. The first and second polarizing plates 313 and 314 transmit only light vibrating in a direction that is substantially parallel to a transmittance axis thereof and absorb and reflect the remaining light vibrating in a different direction. For example, the transmittance axes of the first and second polarizing plates 313 and 314 are substantially perpendicular to each other.

The first light unit 320 includes a first light guide plate 322 disposed on the first buffer member 340 and at least one first light source 324 disposed on a side or edge portion of the first light guide plate 322 for generating light.

The first light source 324 is disposed on the side or edge portion of the first light guide plate 322 and generates light by using an external power supply. The first light source 324, for example, includes a light emitting diode (“LED”). The LED emits light in a predetermined angle range, and therefore, the first light source 324 desirably includes a plurality of the LEDs to emit uniform light toward the first light guide plate 322. The number of the LEDs may vary with respect to an emission angle and a size of the first light guide plate 322.

On the other hand, the first light source 324 may include a cold cathode fluorescent lamp (“CCFL”) having a longitudinally cylindrical shape.

The first light guide plate 322 guides the light generated by the first light source 324 and transforms a point light into a planar light to emit the transformed light to advance toward the display panel 310.

The first light guide plate 322 is formed of a transparent material in order to minimize light loss. For example, the first light guide plate 322 is formed of poly methyl methacrylate (“PMMA”) having a superior hardness or poly carbonate (“PC”) having a heat resisting property.

For light diffusing and reflecting, a light diffusing pattern may be formed on an inner surface of the first light guide plate 322 in contact with the first buffer member 340. A concave-convex pattern in a predetermined depth may be regularly or irregularly formed on the diffusing pattern. The light generated by the first light source 324 and entering the first light guide plate 322 is diffused by the diffusing pattern and, a portion of the light that satisfies a specific condition exits the light guide plate 322 to advance toward the display panel 310.

The first light guide plate 322 disposed on the first buffer member 340 substitutes for a conventional window, thus an outer surface opposite to the inner surface of the first light guide 322 is exposed externally. Therefore, in order to prevent scratches and the like, the outer surface of the first light guide 322 undergoes a hard coating treatment with transparent resins, such as a silicone-oxide, for example.

The second light unit 330 includes a second light guide plate 332 disposed on the second buffer member 350 and at least one second light source 334 disposed on a side or edge portion of the second light guide plate 332 for generating light.

The second light source 334 is disposed on the side or edge portion of the second light guide plate 332 and generates light by using an external power supply. The second light source 334, for example, includes a light emitting diode (“LED”). The LED emits light in a predetermined angle range, and therefore, the second light source 334 desirably includes a plurality of the LEDs to emit uniform light toward the second light guide plate 332. The number of the LEDs may vary with respect to an emission angle and a size of the second light guide plate 332.

On the other hand, the second light source 334 may include cold cathode fluorescent lamp (“CCFL”) having a longitudinally cylindrical shape.

The second light guide plate 332 guides the light generated by the second light source 334 and transforms a point light into a planar light to emit the transformed light to advance toward the display panel 310.

The second light guide plate 332 is formed of a transparent material in order to minimize light loss. For example, the second light guide plate 332 is formed of poly methyl methacrylate (“PMMA”) having excellent hardness or poly carbonate (“PC”) having a heat resisting property.

For light diffusing and reflecting, a light diffusing pattern may be formed on an inner surface of the second light guide plate 332 in contact with the second buffer member 350. A concave-convex pattern in a predetermined depth may be regularly or irregularly formed on the diffusing pattern. The light generated by the second light source 334 and entering the second light guide plate 332 is diffused by the diffusing pattern, and a portion of the light that satisfies a specific condition exits the light guide plate 322 to advance toward the display panel 310.

The second light guide plate 322 disposed on the second buffer member 350 substitutes for a conventional window, thus an outer surface opposite the inner surface of the second light guide 332 is exposed externally. Therefore, in order to prevent scratches and the like, the outer surface of the second light guide 332 undergoes a hard coating treatment with transparent resins, such as a silicone-oxide, for example.

The display module 300 may further include a mold frame or a chassis frame, and so on, for fixing the elements described above.

The display module 300 is received and fixed in the first case 400 and the second case 500.

The first case 400 includes the first opening portion 410 for externally exposing the first light guide plate 322 and the second case 500 includes the second opening portion 510 (see FIG. 2) for externally exposing the second light guide plate 332. The first light guide plate 322 is disposed in the first opening portion 410 and the second light guide plate 332 is disposed in the second opening portion 510.

Here, the outer surface of the first case 400 is substantially coplanar (e.g., flush) with the outer surface of the first light guide plate 322 and the outer surface of the second case 500 is substantially coplanar with the outer surface of the second light guide plate 332. Alternatively, the outer surface of the first light guide plate 322 may be disposed slightly lower (e.g., recessed) than the outer surface of the first case 400 and the outer surface of the second light guide plate 332 may be disposed slightly lower than the outer surface of the second case 500.

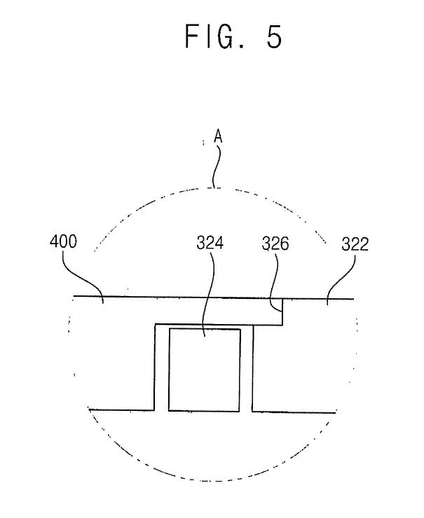

FIG. 5 is an enlarged view showing a portion A in FIG. 3.

Referring to FIG. 5, a recess 326 is formed at an edge portion of the outer surface of the first light guide plate 322, with an end stepped portion of the first case 400 inserted into the recess 326. The end stepped portion of the first case 400 is inserted into the recess 326 and thus the first light guide plate 322 is securely fixed.

The second light guide plate 332 and the second case 500 in FIG. 3 are combined with each other using the same structure as the first light guide plate 322 and the first case 400.

In this manner, the first and second light guide plates 322 and 332 are disposed on the upper portion and the lower portion of the display panel 310, respectively, and the first and second buffer members 340 and 350 are disposed between the first and second light guide plates 322 and 332, respectively. Therefore, a thickness of the display device 200 decreases.

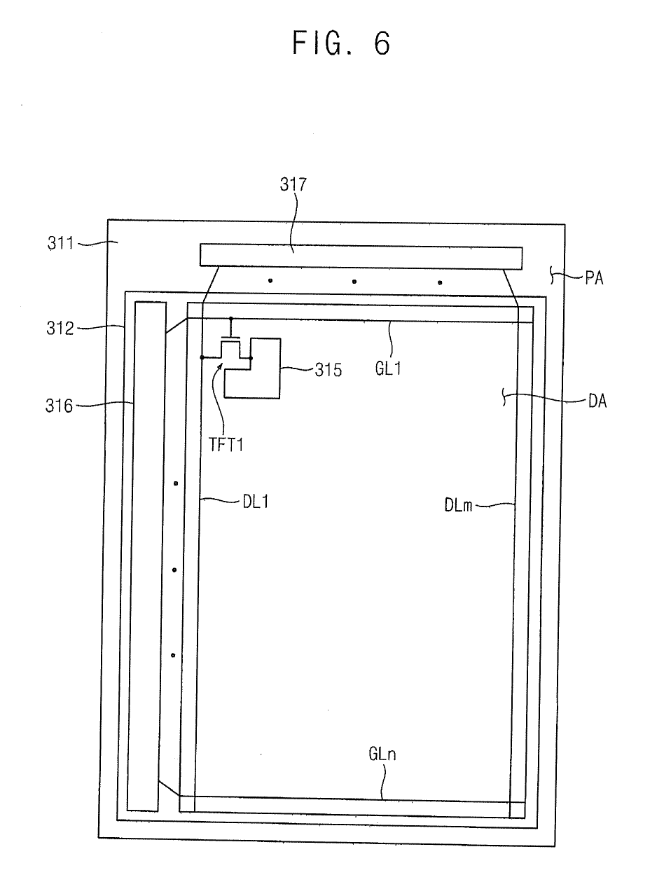

FIG. 6 is a plan view showing a schematic diagram of the display panel in FIG. 4.

Referring to FIGS. 4 and 6, the display panel 310 includes the first substrate 311, the second substrate 312 opposite to the first substrate 311 and the liquid crystal layer interposed between the first and second substrates 311 and 312.

The display panel 310 includes a display area DA for displaying images and a peripheral area PA surrounding the display area DA.

The first substrate 311 includes a plurality of gate lines GL1˜GLn and a plurality of data lines DL1˜DLm intersecting the gate lines GL1˜GLn. The gate lines GL1˜GLn and the data lines DL1˜DLm are formed in the display area DA, wherein ‘n’ and ‘m’ are natural numbers. The gate lines GL1˜GLn and the data lines DL1˜DLm are insulatively disposed on different layers.

The first substrate 311 may further include a plurality of thin film transistors (“TFTs”) and a plurality of pixel electrodes arranged in a matrix configuration. The TFTs and the pixel electrodes are disposed in the display area DA. For example, a gate electrode of a first TFT is connected to a first gate line GL1 of the gate lines GL1˜GLn, a source electrode is connected to a first data line DL1 of the data lines DL1˜DLn and a drain electrode is connected to a first pixel electrode 315.

The first substrate 311 may further include a gate driving circuit 316. The gate driving circuit 316 includes a shift register including a plurality of driving transistors.

The gate driving circuit 316 applies gate driving signals to gate lines GL1˜GLn in response to gate control signals applied externally. The gate driving circuit 316 is formed in the peripheral area PA.

The gate driving circuit 316 is simultaneously formed by a thin film process of forming the gate lines GL1˜GLn, the data lines DL1˜DLm and the TFTs.

The second substrate 312 includes a color filter layer for displaying colors and a common electrode opposite to the pixel electrode of the first substrate 311. Alternatively, the color filter layer may be formed on the first substrate 311.

The liquid crystal layer disposed between the first substrate 311 and the second substrate 312 includes liquid crystal molecules having specific electric and optical properties, for example, such as an anisotropic dielectric constant and an anisotropic refractive index, respectively, for example. For example, the liquid crystal layer includes a twist nematic (“TN”) liquid crystal tilted by an electric field formed between the pixel electrode and the common electrode.

The display panel 310 further includes a driving chip 317 mounted on the peripheral area PA. The driving chip 317, for example, is electrically connected to the first substrate 311 through an anisotropic conductive film (“ACF”).

The driving chip 317 outputs a data driving signal to the data lines DL1˜DLm in response to a data control signal applied externally.

When a power source is applied to a gate terminal of a respective TFT and the TFT is turned on, an electric field is generated between the pixel electrode and the common electrode. Then, an arrangement of liquid crystal molecules disposed between the first substrate 311 and the second substrate 312 are altered by the electric field and the display panel 310 displays an image having a preferred gradation in a manner such that a light transmittance rate is transformed according to a change in the arrangement of liquid crystal molecules.

The display panel 310 displays a main-image toward the second light unit 330 by using the first light supplied from the first light unit 320, and displays a sub-image toward the first light unit 320 by using the second light supplied from the second light unit 330. The main-image and the sub-image displayed by the display panel 310 may be the same or different.

Therefore, the display panel 310 is a transmissive type panel because the first light supplied from the first light unit 320 disposed on the first side of the display panel and the second light supplied from the second light unit 330 disposed on the second side opposite to the first side should penetrate the display panel 310 together.

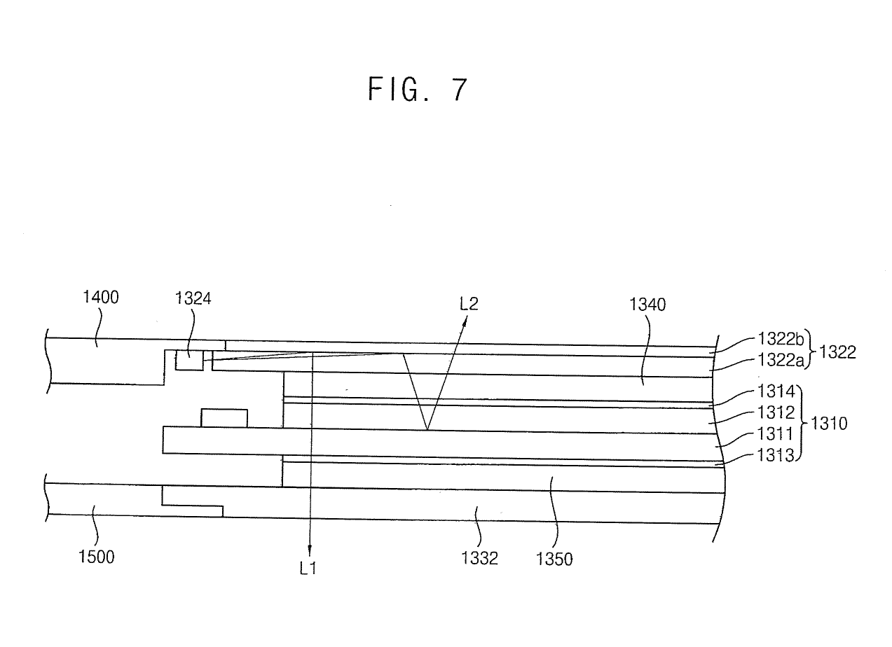

FIG. 7 is a cross-sectional view showing a display device in accordance with another embodiment of the present invention.

Referring to FIG. 7, the display device includes a display module for displaying an image in two directions, a first case 1400 and a second case 1500 for receiving and fixing the display module.

The display device includes a display panel 1310, a light unit, an opposite plate 1332, a first buffer member 1340 and a second buffer member 1350.

The display panel 1310 displays an image in two directions by using light supplied from the light unit.

The light unit includes a light guide plate 1322 disposed on the first buffer member 1340 and at least one light source 1324 disposed on a side or edge portion of the light guide plate 1322 for generating light.

The light guide plate 1322 includes a light guiding layer 1322a and a covering layer 1322b. The light guiding layer 1322a guides the light generated from the light source 1324 toward the display panel 1310. The covering layer 1322b covers an outer surface of the light guide plate 1322 to protect the light guide plate 1322. In addition, the covering layer 1322b may reflect the light generated from the light source 1324 and may transmit a second light L2 reflected from the display panel 1310. For example, the covering layer 1322b may include glass, transparent synthetic resin, etc. Alternatively, a plurality of optical patterns (not shown) may be formed on the covering layer 1322b to guide the light.

The light source 1324 is disposed on the side or edge portion of the light guide plate 1322 and generates light by using an external power supply.

The opposite plate 1332 is disposed on the second buffer member 1350 opposite to the light guide plate 1322. For example, the opposite plate 1332 may include transparent synthetic resin, glass, etc.

The first buffer member 1340 is interposed between the light guide plate 1322 and the display panel 1310. The second buffer member 1350 is interposed between the opposite plate 1332 and the display panel 1310. Alternatively, the second buffer member 1350 may be omitted so that the display panel 1310 is spaced apart from the opposite plate 1332 by a constant distance.

The display panel 1310 includes a first substrate 1311, a second substrate 1312 opposite to the first substrate 1311 and a liquid crystal layer (not shown) interposed between the first and second substrates 1311 and 1312. The first substrate 1311 includes a plurality of transmitting pixels (not shown) arranged in a matrix shape and a plurality of reflecting pixels (not shown) arranged in a matrix shape between adjacent transmitting pixels.

The display panel 1310 may further include a first polarizing plate 1313 attached on an outer surface of the first substrate 1311 and a second polarizing plate 1314 attached on an outer surface of the second substrate 1314.

The light generated from the light source 1324 is guided toward the display panel 1310, and is divided into a first light L1 and the second light L2. The display panel 1310 displays a main-image toward the opposite plate 1332 by using the first light L1 that has passed through the transmitting pixels. In addition, the display panel 1310 displays a sub-image toward the light guide plate 1322 by using the second light L2 that is reflected from the reflecting pixels.

In FIG. 7, the light unit is disposed on a front side of the display panel 310 and supplies the display panel 310 with the light. Alternatively, the light unit may be disposed on a rear side of the display panel 310 and supplies the display panel 310 with the light.

According to the display device, each of the light units is disposed on a respective side of the display panel, with the display panel interposed between the buffer members. Therefore, a thickness of the display device can be decreased.

Also, a light guide plate included in each of the light units substitute for a conventional window, so that the whole thickness of the display device considerably decreases.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display device comprising:
a display panel configured to display an image;
a first light unit disposed on a first side of the display panel, the first light unit configured to supply light to the display panel;
a second light unit disposed on a second side opposite to the first side of the display panel, the second light unit configured to supply light to the display panel;
a first buffer member disposed between the display panel and the first light unit; and
a second buffer member disposed between the display panel and the second light unit.

2. The display device of claim 1, wherein the first and second buffer members include transparent resins having elasticity.

3. The display device of claim 2, wherein the first and second buffer members include silicone.

4. The display device of claim 2, wherein the first and second buffer members have an adhesive property.

5. The display device of claim 1,
wherein the first light unit comprises:
a first light guide plate disposed on the first buffer member; and
at least one first light source disposed on a side or edge portion of the first light guide plate, and generating light.

6. The display device of claim 1, wherein the second light unit comprises:
a second light guide plate disposed on the second buffer member; and
at least one second light source disposed on a side or edge portion of the second light guide plate, and generating light.

7. The display device of claim 1, wherein the display panel is a transmissive type panel.

8. The display panel of claim 7, wherein the display panel comprises:
a first substrate;
a second substrate opposite to the first substrate; and
a liquid crystal layer interposed between the first and second substrates.

9. The display device of claim 1, further comprising:
a first case including a first opening portion exposing the first light unit; and
a second case including a second opening portion exposing the second light unit, the second case combined with the first case.

10. The display device of claim 9, wherein an outer surface of the first case is substantially coplanar with an outer surface of the first light guide plate and an outer surface of the second case is substantially coplanar with an outer surface of the second light guide plate.

11. A display device comprising:
a display module including:
a display panel displaying an image;
a first light unit disposed on a first side of the display panel, the first light unit configured to supply light to the display panel;
a second light unit disposed on a second side opposed to the first side of the display panel, the second light unit configured to supply light to the display panel;
a first buffer member disposed between the display panel and the first light unit; and
a second buffer member disposed between the display panel and the second light unit;
a first case configured to fix the first light unit; and
a second case configured to fix the second light unit, the second case combined with the first case.

12. The display device of claim 11, wherein the first light unit includes:
a first light guide plate disposed on the first buffer member; and
at least one first light source disposed on a side or edge portion of the first light guide plate, to generate light.

13. The display device of claim 12, wherein the second light unit includes:
a second light guide plate disposed on the second buffer member; and
at least one second light source disposed on a side or edge portion of the second light guide plate, to generate light.

14. The display device of claim 13, wherein the first case includes a first opening portion exposing the first light guide plate, and the second case includes a second opening portion exposing the second light guide plate.

15. The display device of claim 14, wherein an outer surface of the first case is substantially coplanar with an outer surface of the first light guide plate, and an outer surface of the second case is substantially coplanar with an outer surface of the second light guide plate.

16. The display device of claim 14, wherein the outer surface of the first light guide plate and the outer surface of the second light guide plate are hard coated.

17. The display device of claim 16, wherein the outer surface of each of the first and second light guide plates comprises a covering layer including glass.

18. The display device of claim 11, wherein the first and second buffer members include transparent resins having a predetermined elasticity.

19. The display device of claim 11, wherein the display panel is a transmissive type panel.

20. The display device of claim 11, wherein the second light unit does not operate when the first light unit is operated, and the first light unit does not operate when the second light unit is operated.

21. A display device comprising:
a display panel configured to display an image;
a light unit disposed on a first side of the display panel, the light unit configured to supply light to the display panel;
an opposite plate disposed on a second side of the display panel; and
a buffer member disposed between the display panel and the light unit.

22. The display device of claim 21, further comprising an opposite buffer member disposed between the display panel and the opposite plate.
